(19) United States
(12) Patent Application Publication
(10) Pub. No.: US 2007/0048473 A1
(43) Pub. Date: Mar. 1, 2007

(54) Injection stretch blow-molded container

(75) Inventors: William John Connolly, Windlesham (BE); Patrick Jean-Francois Etesse, Etterbeek (BE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/346,960

(22) Filed: Feb. 3, 2006

(30) Foreign Application Priority Data
Aug. 29, 2005 (EP) 05447194.1

(51) Int. Cl. B32B 27/08

(52) U.S. Cl. 428/35.7

(57) ABSTRACT

An injection stretch blow-molded container 1 consisting essentially of polypropylene, wherein the container is provided with a decoration comprising label or sleeve 6, and characterized in that the label or sleeve 6 consists essentially of polyolefin.

The present invention relates to an injection stretch blow-molded container consisting essentially of polypropylene.

Polypropylene is known in the art as a suitable material from which to manufacture transparent containers. Conventionally, an extrusion blow-molding process has been used, but such a process results in bottles with low transparency and impact strength and consequently has been little used in practice for packaging consumer goods.

EP-A-0 251 340, published on 7 Jan. 1988, discloses a process for producing an injection stretch blow molded container using a parison made from polypropylene-based resin.

The need remains for an economical process for the manufacture, decoration and sealing of a container, preferably a transparent container, which can be used to package consumer goods, and wherein the empty package, after use, can be easily and efficiently recycled.

### SUMMARY OF THE INVENTION

The present invention relates to an injection stretch blow-molded container consisting essentially of polypropylene, wherein the container is provided with a decoration comprising label or sleeve, and characterized in that the label or sleeve consists essentially of polyolefin, preferably polypropylene or polyethylene, most preferably polypropylene.

### BRIEF DESCRIPTION OF THE DRAWINGS

FIG. 1 shows a front elevation of a container.

FIG. 2 shows a decorative sleeve for use in conjunction with the container shown in FIG. 1.

FIG. 3 shows a finished product package comprising the container and decorative sleeve of FIGS. 1 and 2, respectively, and a closure.

### DETAILED DESCRIPTION OF THE INVENTION

Consumer goods such as drinks, foodstuffs, laundry and household cleaning products, shampoo and other personal care products are typically packaged in various forms of containers, such as bottles. Bottles are required to have a certain level of mechanical performance to prevent damage during transport and use, and also provide a level of aesthetic appeal to consumers, in which case transparent, glossy containers are often consumer preferable.

Containers manufactured from thermoplastic polyolefins, including polyethylene and polypropylene, are most commonly manufactured in an extrusion blow-molding process. In such a process molten polyethylene and polypropylene parisons are blown into the shape of an external mold, the flow properties of these thermoplastic materials are such that the material can flow around a fixed insert within the mold cavity and form an integral handle. Containers made by extrusion blow-molding of polyethylene exhibit low transparency, and polypropylene containers show low or moderate transparency and generally low impact strength.

High transparency, glossy containers are commonly made from polyethylene terephthalate (PET), and most commonly manufactured in an injection stretch blow-molding process. In such a process a preformed parison is manufactured via extrusion, injection or compression molding, and either cooled to blow temperature, cooled to room temperature and re-heated, or a combination of the two, before being inserted into a blow mold and formed into the final container. Utilizing this process for polypropylene results in containers of greatly improved stiffness, drop strength, topload, gloss and transparency compared to extrusion blow molded containers of the same material. This improvement enables the use of less resin to produce a container of equal volume and topload. Typically an extrusion blow molded container of polyethylene or polypropylene would weigh a minimum of 40 g/l of contained product, whereas an injection stretch blow-molded container will weigh a maximum of 30 g/l.

Until recently polypropylene was not commercially utilized for injection stretch blow molding due to issues that included preform design, material re-heat and melt properties and blow equipment compatibility. Recent developments in these areas, however, have resulted in improvements in its suitability for injection stretch blow-molding, in a large-scale, economically viable process. Polymers having suitable combinations of melt strength, re-heat properties, transparency and processing window size have been developed, alongside equipment improvements, such that injection stretch blow-molded polypropylene bottles can be produced on high speed equipment with outputs in excess of 1000 bottles/cavity/hour. Standard injection-stretch-blow-molding processes do not allow the production of an integral handle.

Polypropylene is readily available in commercial grades. Materials having suitable combinations of melt strength, re-heat properties, transparency and processing window size are available from suppliers such as Borealis, BP, and Total, e.g. Total's PPR7225.

It is generally necessary for consumer goods to be provided with means of identifying the product and communicating essential product information such as brand name, logo, images, and the like; ingredient information; usage instructions; bar code; hologram etc. Such means are typically labels or sleeves which may be attached to or around the container.

The current invention comprises combining the use of the injection stretch blow-molding process for polypropylene to manufacture a transparent container of good mechanical properties with a polyolefin-based decoration, to produce a package made from a single material, or a combination of chemically similar materials, that are compatible through the recycling process of the majority component. This simplifies the recovery process as the label does not need to be removed for recycling.

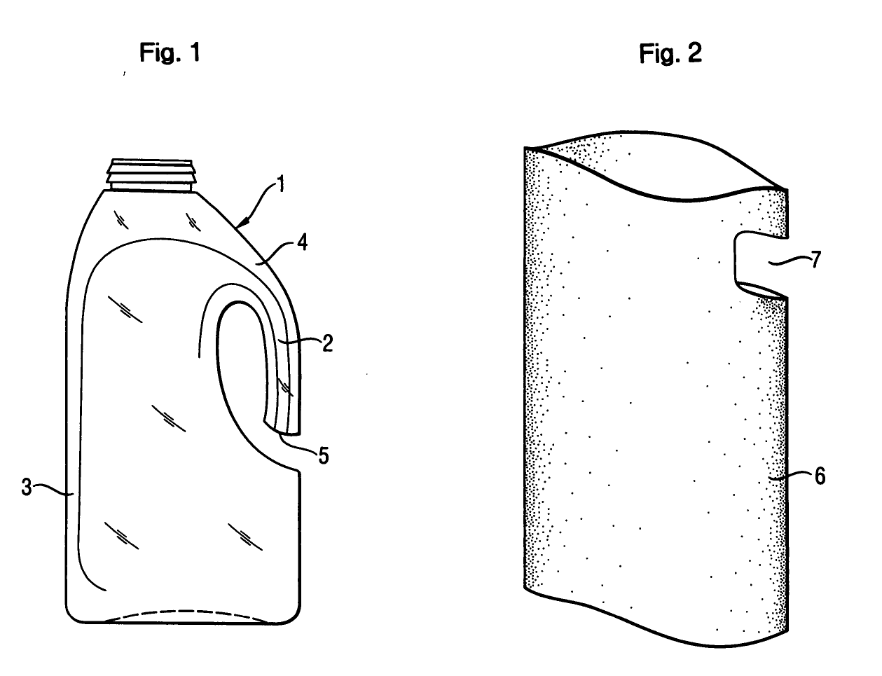

The injection stretch blow-molded container of the present invention is decorated, for example by means of a label or sleeve. Examples of labels are wrap-around, wet-glue, and in-mold labels. Examples of sleeves are stretch sleeves and shrink sleeves. One particular method of sleeving an open handle bottle is described in EP-A-1 238 916, published on 11 Sep. 2002, incorporated herein by reference, which is illustrated in FIGS. 1-3.

It is preferred that the label or sleeve comprises a film substrate which is made from a transparent material. This enables decoration, i.e. brand name, logo, images, and the like; ingredient information; usage instructions; bar code; hologram etc., to be displayed for the consumer, whilst still preserving the aesthetic benefits of the transparent container. Such decoration is printed onto the film substrate by any of various techniques known in the packaging art.

In a particularly advantageous embodiment of the invention the label or sleeve comprises a film substrate which is a polyolefin, and most preferably polypropylene. Material recycling is greatly facilitated, and is therefore more economically viable, because both the bottle material and the film substrate are made from polyolefins, and there is no need to separate them into separate recycling streams. Furthermore, if any additional elements are fitted to the bottle, such as a collar or closure, it is preferred that these additional elements are also made from polypropylene or polyethylene, most preferably polypropylene for the same reason. The finished product package comprises the container together with any label, sleeve, collar, closure and additional elements. Preferably, the finished product package comprises at least 95%, preferably at least 99%, by weight of polypropylene.

Containers are also generally required to have some form of closure mechanism to enclose and protect the contents and to facilitate extraction, dosing and application. These closures take a wide range of formats, are most commonly made from polyolefins, preferably polypropylene. Many containers also have an additional item, such as a dosing ball to further facilitate the use of the product. These items are also commonly made from polyolefins, preferably polypropylene. Polypropylene is an ideal choice for these devices due to its wide range of mechanical properties (including living hinge) that can suit most applications, excellent injection molding properties, good chemical resistance, and relatively low cost. However, as few containers are made from polypropylene, closures will always need to be removed before recycling. This is especially a problem when closures are multi-component, such as with a transition piece that is not intended for removal, or have tamper-evident features that are also intended to remain on the bottle when opened.

In many cases it is preferable for the blow-molded container may be capped with a self draining closure. Self draining containers are known in the art. These containers include means for returning contents which have dripped or run down the exterior of the pouring spout to the main body of the container. Examples of prior art self draining closures are shown in U.S. Pat. No. 4,550,864 and U.S. Pat. No. 4,640,855. Self draining closures are particularly advantageous for highly viscous products that adhere to and drip down the outer surface of a bottle, and for low surface-tension products which will also adhere to the bottle. Prime examples of these products are detergents, which are both viscous and low surface-tension, and have repeat uses from the same container resulting in significant mess. Self-draining closures are often made in more than one piece to facilitate molding and attachment to the bottle, and will usually have a separate cap section.

In a particularly advantageous embodiment of the invention, the closure is an integral part of the container. This can be achieved by injection stretch blow molding the container from a preform, wherein the preform neck comprises a closure so that the blown container is a one piece container comprising integral closure. Most preferably the integral closure is a self-draining spout so that the finished package is a one piece self-draining container as disclosed in U.S. Pat. No. 5,114,659.

One-piece caps with or without living hinges are also an effective method of closure for a container. These closures have a nozzle section and a cap section which is attached by a thin section of the same part. This joint is often made into a living hinge which forces the cap to flip back or to the nozzle from the other position when a small force is applied. These closures are low-cost to produce as they consist of just one piece, and are particularly advantageous for use on products that require one-handed use, such as shampoos and dish detergents. Closures such as this are known in the art.

In addition to simple caps, it is often preferable for package and closure systems to incorporate further items to improve functionality through dosing control, product application direction, or many other common requirements for consumer and professional products. Common examples of these systems can include, but are not limited to, non-return valves, slit-seal valves, dosing chambers, directional and ‘pop’ spouts, rollerballs and pump devices. Polypropylene is the preferred material of choice for the production of the majority of these devices.

A “mold” as described herein generally comprises two or more parts which can be closed to form a “mold cavity”, and opened in order to allow a preform to be inserted into the mold and/or the blown product to be removed from the mold. In commercial operations multiple mold cavities may be combined in a continuous, high-speed machine.

By “preform” what is meant herein is a molded form which is produced prior to expansion to form the finished object. A preform is necessarily somewhat smaller than the finished object. A preform is generally produced by, for example injection molding, at an elevated temperature in excess of the melt temperature.

By “stretch blow-molding” what is meant herein is a process in which the preform is first stretched longitudinally, generally by means of a stretch pin or plunger, followed by a blowing step at a temperature above the glass transition temperature, designed to result in retained orientation in the blow direction so that the resulting configuration is “biaxially oriented”. The appropriate stretch temperature for a polypropylene is between about 140° C. and 150° C.

Relatively large packages, for example 2 litres and above, are preferably provided with a handle so that the consumer can conveniently lift the product and pour from the package even when the package is full.

In a particular embodiment of the present invention the injection stretch blow-molding process comprises two steps: a first blowing step, and, preferably following immediately afterwards, a second blowing step. In the first blowing step inwardly moving jaws within the mold cavity partially grip and fuse the expanding preform. The inward movement of the jaws is completed within the first blowing step. The pressure applied within the preform during the first blowing step is preferably from 1 to 10 bar, more preferably from 3 to 8 bar. Thereafter the pressure applied within the preform is increased in the second blowing step. In the second blowing step the pressure is preferably greater than 10 bar, more preferably maximum pressure is from 12 to 20 bar.

In a particularly preferred further step the completed bottle is then ejected from the mold, and the welded handle section which has been formed by fusing together of plastic material between the moving jaws is removed to create a full through handle.

This embodiment of the present invention provides a blow-molded container comprising a main bottle cavity and an integrally molded, hollow handle cavity, and wherein the main bottle cavity and the hollow handle cavity are interconnected such that fluid can flow freely between the two cavities, characterized in that the blow-molded container comprises bi-orientated polypropylene.

The injection stretch blow-molded container may comprise a hollow handle having two opposing ends, and both of the ends are interconnected to the main cavity body of the container in such a way that fluid can freely flow between the hollow handle and the main cavity body through either or both of the ends of the hollow handle.

Alternatively, as illustrated in FIGS. 1 to 3, the injection stretch blow-molded container 1 may comprise a hollow handle 2 having two opposing ends 4, 5, one of the ends 4 is interconnected to the main cavity body 3 of the container, and the other end 5 is closed. Fluid can freely flow between the hollow handle 2 and the main cavity body 3 only through one of the ends of the hollow handle 2. Such a container 1 is sometimes referred to as having an “open handle”.

FIG. 2 shows a decorative sleeve 6 suitable for use in conjunction with the open-handled bottle. The sleeve 6 shown in FIG. 2 comprises a cut-out section 7 which fits over and around the open handle 2.

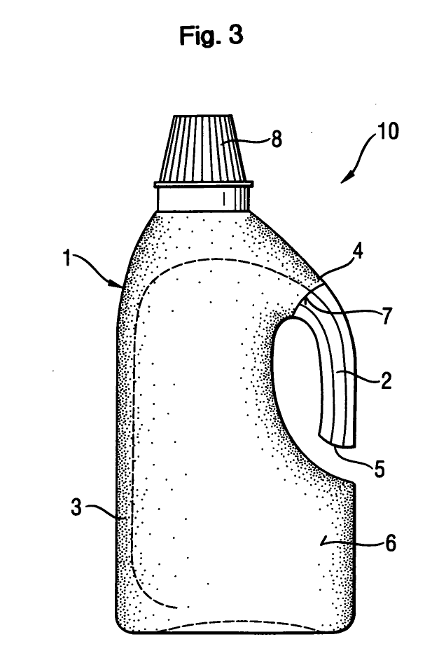

FIG. 3 shows a finished product package 10 comprising the container 1, decorative sleeve 6, and closure 8. According to the present invention the container 1 is injection stretch-blow molded from polypropylene; the decorative sleeve is made from a polyolefin, preferably polypropylene; and the closure is made from a polyolefin, preferably polypropylene.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An injection stretch blow-molded container (1) consisting essentially of polypropylene, wherein the container (1) is provided with a decoration comprising label or sleeve (6), and wherein the label or sleeve (6) consists essentially of polyolefin.

2. An injection stretch blow-molded container according to claim 1, wherein the label or sleeve (6) comprises a film substrate upon which the decoration is printed.

3. An injection stretch blow-molded container according to claim 1, wherein the label or sleeve (6) comprises a film substrate upon which the decoration is printed, and wherein the film substrate is polypropylene or polyethylene.

4. An injection stretch blow-molded container according to claim 3 wherein the film substrate is polypropylene.

5. An injection stretch blow-molded container according to claim 2 wherein the film substrate is a transparent material.

6. A finished product package (10) comprising an injection stretch blow-molded container (1) consisting essentially of polypropylene, wherein the container (1) is provided with a decoration comprising label or sleeve (6), wherein the label or sleeve (6) consists essentially of polyolefin, wherein the finished product package (10) further comprises a polypropylene closure (8) and/or polypropylene collar, and wherein the finished product package (10) comprises at least about 95% polypropylene.

7. A finished product package (10) comprising at least about 99% by weight of polypropylene.

8. An injection stretch blow-molded container according to claim 6, wherein the label or sleeve (6) comprises a film substrate upon which the decoration is printed.

9. An injection stretch blow-molded container according to claim 7, wherein the label or sleeve (6) comprises a film substrate upon which the decoration is printed, and wherein the film substrate is polypropylene or polyethylene.

10. An injection stretch blow-molded container according to claim 9 wherein the film substrate is polypropylene.

11. An injection stretch blow-molded container according to claim 9 wherein the film substrate is a transparent material.

12. A finished product package according to claim 6, wherein the container is injection stretch blow-molded from a preform, wherein the preform neck comprises a closure so that the blown container is a one piece container comprising integral closure.

13. A finished product package according to claim 12, wherein the integral closure is a self draining closure.
